(19) United States
(12) Patent Application Publication
(10) Pub. No.: US 2013/0004108 A1
(43) Pub. Date: Jan. 3, 2013

(54) BEARING ASSEMBLY COMPRISING A BEARING

(75) Inventors: Jens Heim, Bergrheinfeld (DE); Bernhard Wilm, Nudlingen (DE)

(73) Assignee: SCHAEFFLER TECHNOLOGIES AG & CO. KG, Herzogenaurach (DE)

(21) Appl. No.: 13/635,171

(22) PCT Filed: Feb. 10, 2011
(86) PCT No.: PCT/EP11/51973

§ 371 Date: Sep. 14, 2012

(30) Foreign Application Priority Data
Mar. 29, 2010 (DE) 10 2010 013 213.6

(51) Int. Cl. F16C 41/00; F16C 19/00

(52) U.S. Cl. 384/448

(57) ABSTRACT

A bearing assembly (1) for supporting a rotatable component, especially a wheel on a motor vehicle, including a spindle (3), a stationary inner ring (5) and a bearing such as a wheel bearing (4) containing an outer ring (6) that rotates at a certain speed, and a sensor element (11), the sensor element (11) and the inner ring (5) of the wheel bearing (4) being mounted on the spindle (3). In order to prevent the inner ring (5) from being rotated relative to the sensor element (11), the sensor element (11) is mounted on the spindle (3) with a rotationally secure connection and the inner ring (5) is mounted relative to the sensor element (11) with a rotationally secure connection.

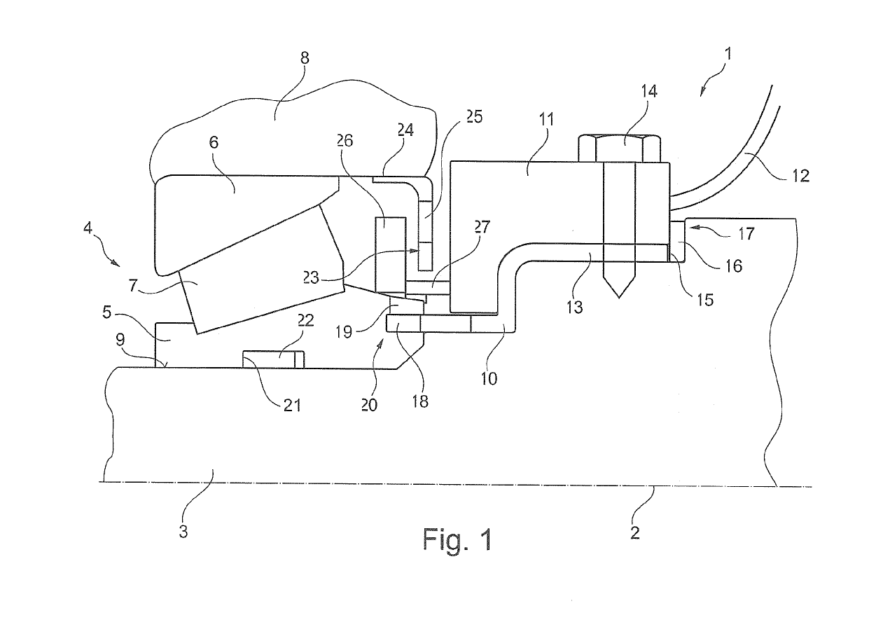

### FIELD OF THE INVENTION

The invention relates to a bearing assembly for supporting a rotatable component, especially a wheel on a motor vehicle, comprising an axle journal, a stationary inner ring, and a bearing containing an outer ring that rotates at a certain speed, and a sensor element, the sensor element and the inner ring of the bearing being mounted on the axle journal.

### BACKGROUND

Bearing assemblies according to this class are used, for example, as wheel bearing devices in motor vehicles, especially utility vehicles such as trucks, buses, and the like. Here, a bearing, such as a wheel bearing, is arranged on an axle journal with an inner ring and an outer ring, and also rolling elements rolling off between these rings, such as, tapered rollers, needles, or balls. Here, the inner ring is shrink-fitted onto the axle journal and optionally secured against rotation and slippage by means of a pin or cotter-pin. The tolerance of such rotational locking must have a relatively large design.

In the bearing assembly, a sensor element can be integrated that can be used for monitoring the wheel bearing or for recording the wheel rotational speed. Here, a wheel bearing is known from DE 10 2008 023 588 A1 in which a sensor element is connected rigidly to the axle journal and this sensor element detects the rotational speed of a transmitter ring rotating with the outer ring. The tolerance chain between the sensor element and the transmitter ring here extends from the sleeve holding the sensor element via the axle journal, the races of the rolling elements, and the rolling elements to the outer ring and from there via a mount connection to the transmitter ring.

The inner ring of bearings, like wheel bearings, is rotationally locked according to the prior art relative to the axle journal by means of wedges or fitted keys engaging in a groove of the cylinder surface of the inner ring. In addition to increased costs due to the additional component, an especially high load is applied to the inner ring at this groove in the area of the cylinder surface.

### SUMMARY

The object of the invention is to disclose a bearing assembly in which the inner ring is locked in rotation in a simple way and the sensor element is mounted centered on the axle journal.

This objective is met by a bearing assembly for bearing a rotating element, for example, a wheel, especially on a motor vehicle, comprising an axle journal, a stationary inner ring, and a wheel bearing containing an outer ring rotating at a certain rotational speed, for example, the rotational speed of the wheel, and a sensor element, wherein the sensor element and the inner ring of the bearing, such as a wheel bearing, are mounted on the axle journal, the sensor element connected in a rotationally secure manner to the axle journal, and the inner ring is connected in a rotationally secure manner relative to the sensor element.

The proposed bearing assembly is suitable especially for motor vehicles, for example, utility vehicles, such as trucks, rail vehicles, and buses, but also for passenger cars and for non-driven vehicles, such as trailers and stationary applications, wherein a wheel is understood to be a component rotating with the axle journal relative to a stationary axle.

According to the inventive concept, the sensor element is arranged on the axle journal so that a parameter characterizing the behavior of the wheel bearing can be detected. For example, the sensor element could measure the distance of the outer ring of the wheel bearing, so that wheel losses and defects of the wheel bearing can be identified by the detection of deviations. The use of the sensor element as a rotational speed detecting device for detecting the rotational speed of the wheel has proven to be especially advantageous. Here, the sensor element detects rotational angle-dependent signals that are produced, for example, induced in the sensor element by a transmitter ring mounted on the outer ring. Here, time-dependent angular increments are detected by the sensor element, with these increments giving the rotational angle of the wheel. The rotational speed, the angular velocity, and the angular acceleration can be calculated by mathematical transformations and time derivatives.

It has proven advantageous when the sensor element is positioned, for example, exactly centered relative to the axle journal by means of the rotationally secure connection, wherein the sensor element can be fastened on the axle journal by means of one or more screws and the exact positioning of the sensor element relative to the axle journal is realized by means of the rotationally secure connection. Here, the sensor element could have a support part that forms a positive-fit connection in the peripheral direction both with the inner ring and also with the axle journal. For example, the support part could be made from metal and hold the sensor element. For realizing the rotational locking or exact positioning of the sensor element both relative to the inner ring and also relative to the axle journal, the support part can have at least one radially extended tab that engages in at least one complementary recess of the inner ring or of the axle journal. Here, the support part positions the sensor element relative to the inner ring and the axle journal, as well as the axle journal relative to the inner ring, while forming short tolerance chains. An additional component for the rotationally secure connection of the inner ring relative to the axle journal is eliminated. By forming a radial recess, the loads of the inner ring are reduced compared with arrangements with an annular groove on the inner ring in connection with a wedge or the like. In addition, the sensor element is positioned with high accuracy in the rotational direction on the axle journal, so that the angular resolution of the sensor element as a rotational speed detecting device can be increased and can be maintained over the service life, even if the screw connection that has tolerances due to vibrations would allow play between the sensor element and the axle journal.

Through the direct contacting of the sensor element with the radial bearing, for example, by means of the support part, a simple transfer of data can be established by means of the rotationally secure connection of the sensor element or other stationary evaluation units to the elements arranged directly on the wheel bearing, for example, additional sensors. Consequently, at least one additional sensor element, for example, a sensor, can be arranged in open structural spaces of the wheel bearing, with this sensor element detecting other typical parameters of the wheel bearing and transmitting these parameters by means of data transfer to the sensor element that forms the evaluation unit for this at least one sensor or to a separate evaluation unit.

Advantageously an electromagnetic interface is set up between the support part and the inner ring, wherein, in the simplest case, this interface transmits data from a passive sensor via the support part. In addition, an active sensor can be supplied with energy, for example, electrical energy and can be controlled by the evaluation unit, for example, calibrated, parameterized, and the like. A plug-in connection between the support part and the inner ring can be used for this purpose. For protection from corrosion and other damaging effects, the data can be transmitted telemetrically via the electromagnetic interface. For transmitting information and/or energy, the electromagnetic interface can have, in addition or alternatively, optically, inductively, and/or capacitively coupled transmitter components.

The at least one additional sensor can be, for example, a temperature sensor, an acceleration sensor, a pressure sensor, such as a piezo element, a structure-borne sound sensor, and/or the like, so that a monitoring of the wheel bearing can take place at multiple areas and therefore comprehensively, so that wheel dropping, bearing friction, bearing play, bearing temperature, and the like can be detected according to the design of the sensors.

It has proven advantageous, for example, when an additional sensor is arranged in a recess of the inner ring between the inner ring and axle journal. This sensor can be, for example, a temperature sensor or a pressure sensor. Alternatively or additionally, a sensor could be arranged on the inner ring axially between the rolling elements of the wheel bearing and the sensor element. This sensor could be arranged, for example, axially adjacent to the transmitter ring for the sensor element arranged on the axle journal, wherein the rotational angle of the transmitter ring can be evaluated by the additional sensor according to a different measurement principle, for example, optically, so that differential signals that can monitor each other can be obtained through redundancy. Alternatively, a sensor for a different parameter, for example, structure-borne sound, could be provided.

### BRIEF DESCRIPTION OF THE DRAWING

The invention will be explained in more detail with reference to the single FIGURE. This FIGURE shows a partial section through a bearing assembly with a wheel bearing and a common rotationally secure connection of the sensor element and the inner ring of the wheel bearing relative to the axle journal.

### DETAILED DESCRIPTION OF THE PREFERRED EMBODIMENT

The FIGURE shows, in a partial section, the bearing assembly 1 arranged about the rotational axis 2, wherein the axle journal 3 is fixed and the wheel bearing 4 is mounted on the axle journal 3 with the inner ring 5 arranged fixed on the axle journal 3 and the outer ring 6 holding the bearing flange 8 for fastening the wheel and also rolling elements 7 rolling between these rings.

The sensor element 11 is mounted on the step-shaped axle journal 3 on the double step 10 extended radially relative to the mounting surface 9 for the inner ring 5. The sensor element 11 with the electrical outgoing line 12 is arranged on the support part 13 and screwed together with this support part by means of the screw 14 with the axle journal 3. The sensor element 11 and support part 13 are adapted to the double step 10. The sensor element 11 can be positioned on the support part 13, for example, by means of positioning devices, connected to this support part, such as, snapped, bonded, or connected in some other way. Alternatively, the support part 13 could be part of the sensor element 11 in that this is integrated, for example, in the housing of the sensor element, for example, injection molded in a housing made from plastic. The support part 13 is preferably made from metal, for example, shaped from sheet metal and has a profiled section 15 in which the complementarily shaped counter profiled section 16 of the axle journal 3 is inserted axially for forming the rotationally secure connection 17. The rotationally secure connection 17 has tight tolerances with respect to its play so that exact positioning between the axle journal 3 and the support part 13 and therefore relative to the sensor element 11 is realized. On the opposite side, the support part 13 has the profiled section 18 that forms, with the complementary counter profiled section 19 of the inner ring 5, the rotationally secure connection 20, so that the inner ring 5 is positioned essentially without play relative to the axle journal 3 and the sensor element 11.

In the illustrated embodiment, the sensor element 11 is constructed as a rotational speed detecting device 23 that detects, as an increment sensor, the transmitter markings 25 that are arranged alternating over the periphery of the transmitter ring 24 effectively on the outer ring 6 or mounted structurally on the bearing flange 8. These markings could be webs formed by punched sections. Through the measured number of webs rotating past the sensor element or the signal flanks of an increment sensor generated by these webs, the rotational angle of the bearing flange 8 and thus of the wheel arranged on this flange can be determined. The rotational speed, the angular velocity, and angular acceleration can be determined by evaluating the increments within a specified unit of time, such as the clock rate and the like, as well as their derivatives.

A recess 21 can be provided in the inner ring 5. Another sensor 22, for example, a temperature sensor, a pressure sensor, or the like, can be mounted in this recess.

Another sensor 26 can be arranged in the structural space axially between the rolling elements 7 and the sensor element 11 or behind the transmitter ring 24 that is fastened on the inner ring in the shown embodiment. The output of the signals and optionally a supply of power to the optional sensors 22, 26 is realized in the area of the rotationally secure connection 20 by means of the electromagnetic interface 27 that is shown only schematically and that could be a plug-in connection or an optional bidirectional transmission and reception unit, wherein a supply of power can be realized by means of a capacitive and/or inductive coupling.

### LIST OF REFERENCE SYMBOLS

1 Bearing assembly
2 Rotational axis
3 Axle journal
4 Wheel bearing
5 Inner ring
6 Outer ring
7 Rolling element
8 Bearing flange
9 Mounting surface
10 Double step
11 Sensor element
12 Outgoing line
13 Support part
14 Screw
15 Profiled region
16 Counter profiled region
17 Rotationally secure connection
18 Profiled region
19 Counter profiled region
20 Rotationally secure connection
21 Recess
22 Sensor
23 Rotational speed detecting device
24 Transmitter ring
25 Transmitter marking
26 Sensor
27 Electromagnetic interface

1. Bearing assembly for supporting a rotating component, comprising an axle journal, a stationary inner ring, and a bearing, containing an outer ring rotating at a certain rotational speed, and a sensor element, the sensor element and the inner ring of the bearing are mounted on the axle journal, the sensor element has a rotationally secure connection to the axle journal and the inner ring has a rotationally secure connection relative to the sensor element.

2. Bearing assembly according to claim 1, wherein the sensor element is a rotational speed detecting device for detecting a rotational speed of a rotating component.

3. Bearing assembly according to claim 1, wherein the sensor element has a support part that has a form fit in a peripheral direction both with the inner ring and also with the axle journal.

4. Bearing assembly according to claim 3, wherein the support part engages by at least one radially extended profiled region into a counter profiled region of the inner ring or the axle journal.

5. Bearing assembly according to claim 3, wherein at least one additional sensor is arranged on the inner ring.

6. Bearing assembly according to claim 5, wherein an electromagnetic interface between the at least one additional sensor and a non-rotating evaluation unit is provided between the support part and the inner ring.

7. Bearing assembly according to claim 6, wherein the electromagnetic interface is a plug-in connection.

8. Bearing assembly according to claim 5, wherein the electromagnetic interface is a telemetric or inductive interface.

9. Bearing assembly according to claim 6, wherein the additional sensor is arranged in a recess of the inner ring between the inner ring and the axle journal.

10. Bearing assembly according to claim 6, wherein another sensor is arranged on the inner ring axially between the rolling elements of the wheel bearing and the sensor element.
